(19) United States
(12) Patent Application Publication
(10) Pub. No.: US 2014/0156441 A1
(43) Pub. Date: Jun. 5, 2014

(54) METHODS, SYSTEMS, AND COMPUTER-READABLE MEDIA FOR NETWORK CAPACITY ALLOCATION

(71) Applicant: WeFi Inc., Marlborough, MA (US)

(72) Inventor: Shimon B. Scherzer, Korazim (IL)

(73) Assignee: WeFi Inc., Marlborough, MA (US)

(21) Appl. No.: 14/173,410

(22) Filed: Feb. 5, 2014

Related U.S. Application Data
(63) Continuation of application No. 13/773,173, filed on Feb. 21, 2013.
(60) Provisional application No. 61/757,448, filed on Jan. 28, 2013.
(60) Provisional application No. 61/670,911, filed on Jul. 12, 2012.

(51) Int. Cl. G06Q 30/08

(52) U.S. Cl. CPC G06Q 30/08
USPC 705/26.3

(57) ABSTRACT

Systems, devices, methods, and computer-readable media for auction-based network capacity allocation are disclosed. The systems, devices, methods, and computer-readable media determine network capacity associated with a first wireless network and determine network capacity associated with a second wireless network. The systems, devices, methods, and computer-readable media also output data generated based, at least in part, on the first wireless network capacity determination and the second wireless network capacity determination. In addition, systems, devices, methods, and computer-readable media also receive one or more bids associated with at least some of the network capacity associated with the first wireless network and assign at least some of the network capacity associated with the first wireless network to a purchaser system associated with the second wireless networks as a function of the one or more received bids.

### RELATED APPLICATIONS

This application is a continuation of and claims priority from U.S. patent application Ser. No. 13/773,173, filed Feb. 21, 2013, which is a non-provisional of and claims priority from U.S. Provisional Application No. 61/757,448, filed Jan. 28, 2013, and which is also a non-provisional of and claims priority from U.S. Provisional Application No. 61/670,911, filed Jul. 12, 2012, all of which are incorporated herein by reference.

### TECHNICAL FIELD

The present disclosure relates to the field of network capacity allocation and, more particularly, systems, devices, methods, and computer-readable media for implementing auction-based network capacity allocation.

### BACKGROUND

Cellular networks are increasingly being used for wireless Internet traffic. Such increasing amounts of wireless Internet traffic often create congestion in cellular networks. Cellular network operators often seek ways to alleviate congestion. For example, cellular network operators may attempt to alleviate congestion by increasing the cellular network's bandwidth. However, increasing a cellular network's bandwidth requires operators to invest in and deploy expensive hardware. Moreover, cellular network operators often encounter difficulties in deploying hardware in optimal locations to support the increased bandwidth.

Cellular network operators also may attempt to alleviate congestion by offloading traffic onto other networks such as, for example, a wireless local area network (i.e., “WLAN,” commonly referenced as “Wi-Fi”). The bandwidth provided by a WLAN network is often not fully utilized. However, it is often difficult for cellular network operators to reach an agreeable arrangement with WLAN operators because of the inability to evaluate the cost of bandwidth on WLANs and to assure a WLAN network's quality. For example, a cellular network operator may not be sure how to determine what to pay for a certain amount of data offloaded onto a WLAN network of an unknown quality. Similarly, a WLAN network operator may not be sure how much to charge to enable offloading of a certain amount of data.

Improvements in bandwidth allocation technology, including auction-based network capacity allocation technology, are desirable.

### SUMMARY

In one disclosed embodiment, a network capacity exchange is disclosed. The exchange may include a network capacity management system that comprises at least one processor and at least one memory device comprising instructions which, when executed by the at least one processor, cause network capacity management system to perform the steps of determining network capacity associated with a first wireless network, determining network capacity associated with a second wireless network, outputting data generated based, at least in part, on the first wireless network capacity determination and the second wireless network capacity determination, receiving one or more bids associated with at least some of the network capacity associated with the first wireless network, and assigning at least some of the network capacity associated with the first wireless network to a purchaser system associated with the second wireless network as a function of the one or more received bids. In some embodiments the assigned network capacity is considered excess or available network capacity because it is network capacity that the first wireless network is not fully utilizing during at particular time period and/or at a particular geographical region.

In some embodiments, the highest purchase bid alone will determine the assignment of network capacity. In other embodiments, legal obligations, state regulations, federal regulations, or past experience with the network capacity management system (and/or its operator) may be reflected in the assignment. In some embodiments, a relationship between the networks (and/or or their operators) may be reflected in the assignment. Accordingly, network capacity assignment may reflect one or more factors and may not be based solely on the received bids, although the received bids will generally be one of the factors that the system considers in network capacity assignment.

In another disclosed embodiment, a network capacity management system is disclosed. The network capacity management system comprises at least one processor and at least one memory device comprising instructions which, when executed by the at least one processor, cause network capacity management system to perform the steps of determining network capacity associated with a first wireless network and network capacity associated with a second wireless network, determining, based on the determined network capacity associated with the second wireless network, a purchase value associated with at least some of the network capacity associated with the first wireless network, and outputting the determined purchase value.

In another disclosed embodiment, a method for a network capacity management system is disclosed. The method comprises determining network capacity associated with a first wireless network, determining network capacity associated with a second wireless network, outputting data generated based, at least in part, on the first wireless network capacity determination and the second wireless network capacity determination, receiving one or more bids associated with at least some of the network capacity associated with the first wireless network, and assigning at least some of the network capacity associated with the first wireless network to a purchaser system associated with the second wireless network as a function of the one or more received bids.

In another disclosed embodiment, a method is disclosed. The method comprises determining network capacity associated with a first wireless network and network capacity associated with a second wireless network, determining, based on the determined network capacity associated with the second wireless network, a purchase value associated with at least some of the network capacity associated with the first wireless network, and outputting the determined purchase value.

In another disclosed embodiment, a non-transitory computer-readable medium is disclosed. The non-transitory computer-readable medium comprises instructions for an electronic device, the instructions being executable by a processor of the electronic device for causing the electronic device to perform operations comprising determining network capacity associated with a first wireless network, determining network capacity associated with a second wireless network, outputting data generated based, at least in part, on the first wireless network capacity determination and the second wireless network capacity determination, receiving one or more bids associated with at least some of the network capacity associated with the first wireless network, and assigning at least some of the network capacity associated with the first wireless network to a purchaser system associated with the second wireless network as a function of the one or more received bids.

In another disclosed embodiment, a non-transitory computer-readable medium is disclosed. The non-transitory computer-readable medium comprises instructions for an electronic device, the instructions being executable by a processor of the electronic device for causing the electronic device to perform operations comprising determining network capacity associated with a first wireless network and network capacity associated with a second wireless network, determining, based on the determined network capacity associated with a second wireless network, a purchase value associated with at least some of the network capacity associated with the first wireless network, and outputting the determined purchase value.

Additional aspects related to the embodiments will be set forth in part in the description which follows, and in part will be obvious from the description, or may be learned by practice of the invention.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates an example geographical region comprising networks that may be used for implementing the disclosed embodiments.

FIG. 2 illustrates an example network capacity exchange that may be used for implementing the disclosed embodiments.

FIG. 3 illustrates an example method for allocating network operator capacity.

FIG. 4 illustrates an example method for placing bids on network capacity.

FIG. 5 illustrates an example method for placing revised bids on network capacity.

FIG. 6 illustrates an example interface for entering bids.

FIG. 7 illustrates an example user interface for displaying a user density distribution.

FIG. 8 illustrates an example user interface for displaying a network capacity distribution.

FIG. 9 illustrates an example user interface for identifying locations and times in need of additional network capacity.

FIG. 10 illustrates an example user interface for simulating the effect of purchasing network capacity from a WLAN network.

FIG. 11 illustrates an example user interface for simulating the effect of purchasing network capacity from a plurality of WLAN networks.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Network capacity allocation may be performed in a number of ways. A network capacity exchange may be provided in which network capacity may be exchanged between different entities, such as, for example, between cellular network operators and WLAN operators. The network capacity exchange is configured to provide a number of functions. For example, the network capacity exchange may determine a purchase value (e.g., a recommended purchase bid, a recommended sale bid, a required purchase price, and/or a required sale price) associated with network capacity offered by an entity. The network capacity exchange may also include functionality to clear a transaction comprising the transfer of network capacity between one or more entities and/or to enforce the transaction after it has cleared.

In some embodiments, user devices may be installed with software and/or hardware that collect user-experience data, such as, for example, data regarding network speed and/or other quality data of networks that the devices connect to. These devices may operate in connection with cellular networks, WLAN networks, a combination of both, or even other network types and network combinations. Embodiments are disclosed in which, based on the network speed and/or other quality data of the networks, data derived from the network speed and/or other quality data is provided to interested entities. For example, this data may be displayed to cellular network operators and/or WLAN operators using the network capacity exchange. Moreover, embodiments are disclosed in which, based on the network speed and/or other quality data of the networks, users like the cellular network operators and/or WLAN operators purchase network capacity that the WLAN operators can supply.

Embodiments are disclosed in which an auction is provided with one or more users purchasing network capacity and/or one or more users selling network capacity place bids on the network capacity. In such embodiments, the network capacity exchange may provide the users purchasing network capacity with recommended purchase bids and/or may provide users selling network capacity with recommended sale bids. Users may determine actual purchase bids and/or sale bids to place in an auction based on recommended bids. Alternatively, the network capacity exchange may provide the users purchasing network capacity with required purchase prices and/or required sale prices. Users may be required to place actual purchase bids and/or sale bids to place in an auction based on the required purchase prices and/or required sale prices. Based on purchase and/or sale bids received in an auction, the network capacity exchange system may allocate network capacity. In some embodiments, the network capacity exchange also or alternatively enables a user to purchase network capacity outside of the auction environment based, for example, on the required purchase price. Moreover, the network capacity exchange also or alternatively may enable a user to sell network capacity outside of the auction environment based, for example, on the required sale price. In addition, embodiments are disclosed in which, based on the network speed and/or other quality data of the networks, the effect of purchasing network capacity from a WLAN operator is simulated and/or measured.

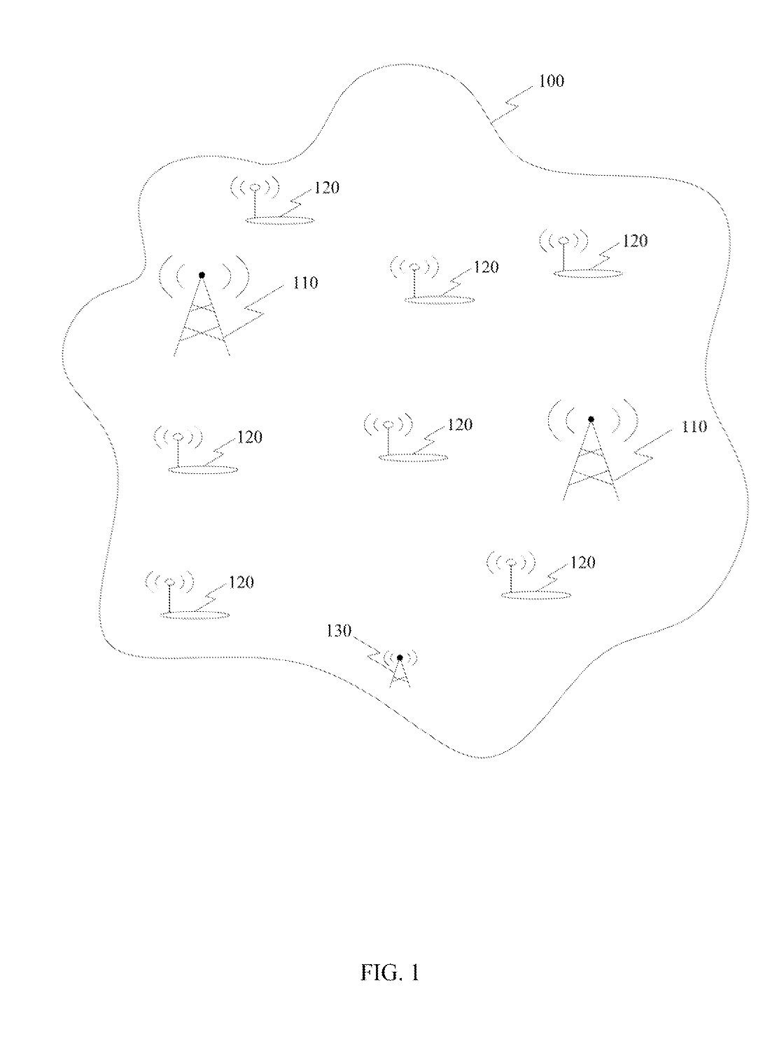

FIG. 1 is a diagram illustrating an example geographical region 100 according to some disclosed embodiments. Geographic region 100 may be, for example, an area within a city, state, or country, or any other geographical area. In some embodiments, geographical region 100 comprises a number of transceivers 110 configured to manage communications in a cellular network protocol, a number of transceivers 120 configured to manage communications in a WLAN network protocol, and a number of other transceivers, such as, for example, transceivers 130 configured to manage communications in a small cell network protocol. In some embodiments, the area serviced (i.e., the area provided wireless network coverage) by one or more cellular networks' transceivers 110, one or more WLAN networks' transceivers 120, and/or one or more other transceivers, can overlap. For example, a cellular transceiver 110 may provide cellular network coverage for a first area and a WLAN transceiver 120 may provide WLAN network coverage for a second area that at least partially overlaps the first area. Each of the one or more cellular transceivers 110 may be operated by the same cellular operator or different cellular operators. Similarly, each of the WLAN transceivers 120 may be operated by the same WLAN operator or different WLAN operators. While FIG. 1 depicts a specific number of cellular transceivers 110, WLAN transceivers 120, and small cell network transceivers 130, in some embodiments geographical region 100 includes any number of cellular transceivers 110, WLAN transceivers 120, and small cell network transceivers 130, including no cellular transceivers 110, WLAN transceivers 120, or small cell network transceivers 130.

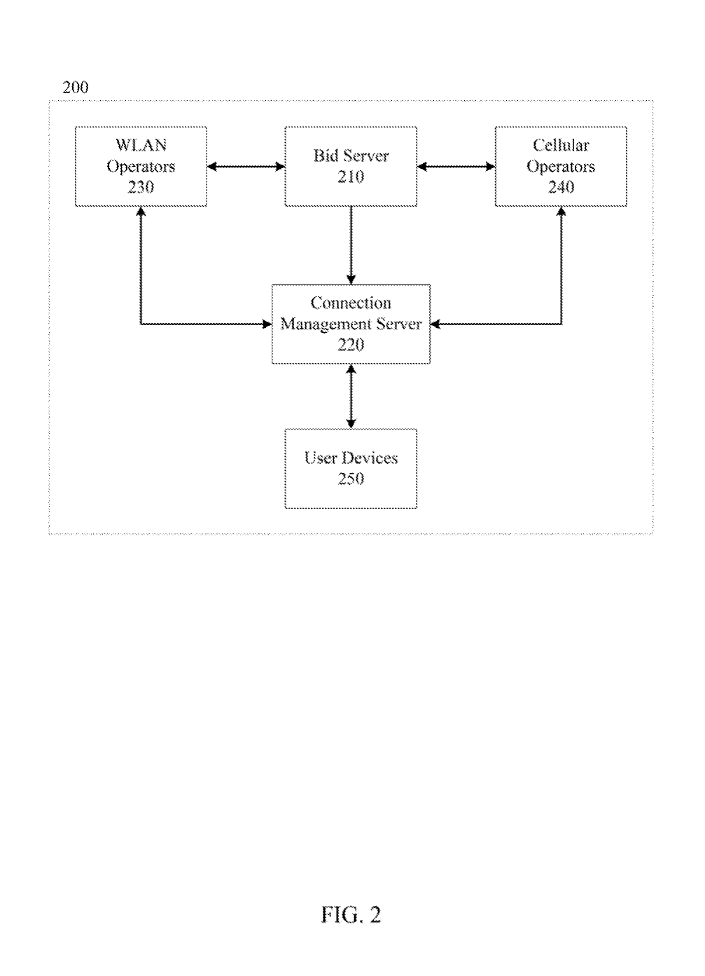

FIG. 2 is a diagram illustrating an example network capacity management system 200 that the network capacity exchange uses to implement the disclosed embodiments. In some embodiments, system 200 includes one or more Bid Servers 210, one or more WLAN/Cellular Connection Management Servers 220, one or more WLAN Operators 230, one or more Cellular Operators 240, and one or more User Devices 250. Bid Servers 210, WLAN/Cellular Connection Management Servers 220, WLAN Operators 230, Cellular Operators 240, and User Devices 250 represent data processing apparatuses and may each include, among other things, one or more of the following components: central processing unit (CPU) configured to execute computer program code to perform various processes and methods, including the embodiments herein described; memory, such as RAM, EEPROM, and flash memory, to store data and computer program code; and an input/output device configured to enable data communication with other components.

In some embodiments, each WLAN Operator 230 controls, directly or indirectly, one or more WLAN transceivers 120 and/or one or more other networks, such as one or more small cell network transceivers 130. In addition, in some embodiments, each Cellular Operator 240 controls, directly or indirectly, one or more cellular transceivers 110. In some embodiments, WLAN Operator 230 and Cellular Operator 240 communicate with Bid Server 210 and/or Connection Management Server 220 regarding an auction for network capacity.

In some embodiments, User Devices 250 comprise hardware and/or computer program code for connecting to cellular transceivers 110, WLAN transceivers 120, and/or other networks, such as small cell network transceivers 130. In some embodiments, User Devices 250 are associated with one or more WLAN Operators 230 and/or one or more Cellular Operators 240. For example, a first set of User Devices 250 may be associated with a first Cellular Operator 240 and a second set of User Devices 250 may be associated with a second Cellular Operator 240. Moreover, in some embodiments, each User Device 250 comprises a database for storing information to enable the User Device 250 to connect to particular networks, such as cellular transceivers 110, WLAN transceivers 120, and/or small cell network transceivers 130 associated with one or more WLAN Operators 230 and/or one or more Cellular Operators 240. For example, as described in more detail in U.S. Pat. No. 8,000,276, incorporated herein by reference, User Devices 250 may comprise login information for a set of networks. In some embodiments, User Devices 250 are capable of receiving data from WLAN/Cellular Connection Management Server 220 to enable User Devices 250 to connect to networks. Moreover, in some embodiments, User Devices 250 are capable of transmitting data regarding the network speed and/or other quality data experienced when connected to one or more networks. For example, the data provided by User Devices 250 to Connection Management Server 220 may include network-usage data and network-speed data, which may be used by Connection Management Server 220 to estimate available network capacity. As used in this application, network capacity may refer to one or more of the following: the bandwidth associated with a network (e.g., the total amount of data that a network may send and/or receive), the excess bandwidth associated with a network (e.g., the difference between the total amount of data that a network may send and/or receive and the amount of data that a network actually sends and/or receives), the network speed associated with a network, and/or other communication resources associated with a network.

In some embodiments, Connection Management Server 220 provides the data provided by User Devices 250 and/or data derived from the data provided by User Devices 250 to one or more WLAN Operators 230 and/or one or more Cellular Operators 240. The one or more Cellular Operators 240 may use the data to determine a price to offer to pay for offered network capacity based on, for example, the effect of winning the additional network capacity on one or more cellular networks and the estimated willingness of the WLAN Operator associated with the offered network capacity to sell the network capacity. The one or more WLAN Operators 230 may use the data to determine a price to offer to sell offered network capacity based on, for example, the effect of selling the network capacity on one or more WLAN networks and the estimated willingness of the one or more Cellular Operators 240 to buy the network capacity.

As depicted in FIG. 2, in some embodiments Bid Server 210 and WLAN/Cellular Connection Management Server 220 are each employed in a single server or set of servers. However, in other embodiments, the functionality of Bid Server 210 and WLAN/Cellular Connection Management Server 220, described in more detail below, are employed together in a single server or set of servers.

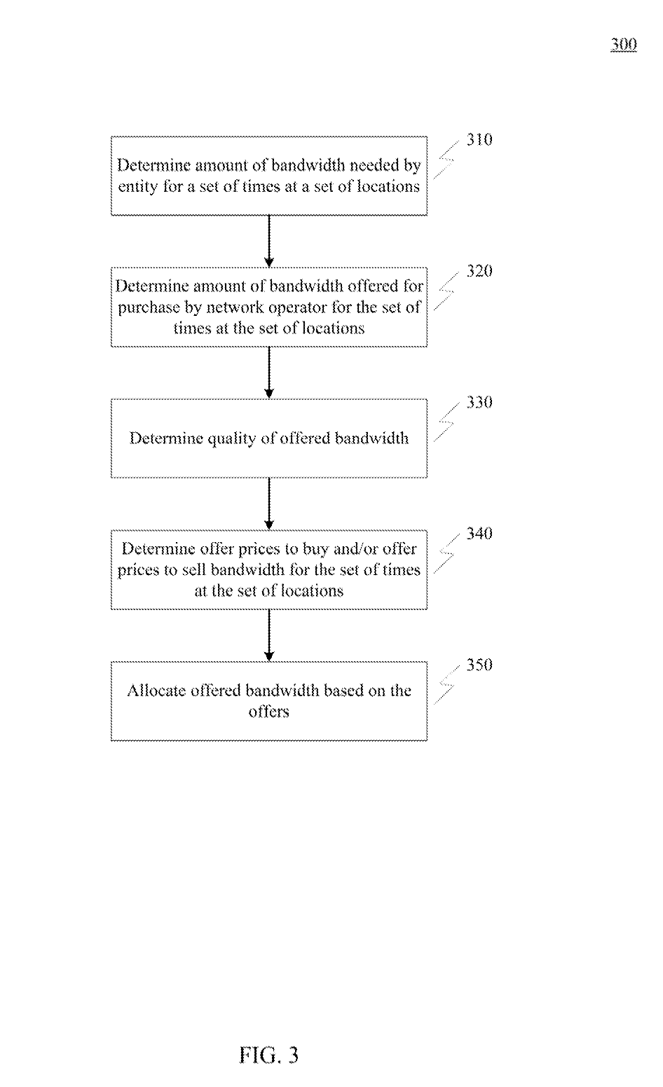

FIG. 3 depicts an example method 300 for allocating network operator network capacity. In some embodiments method 300 may be implemented as one or more computer programs. Method 300 begins with a determination of the amount of network capacity needed by one or more entities, such as Cellular Operators 240, at one or more times and at one or more locations (step 310). In this regard, a location refers to a coverage area, each coverage area contains one or more wireless transceivers positioned at one or more locations within the coverage area as shown, for example, in FIG. 1.

For example, traffic load on a cellular network may vary with time and location. For example, the cellular traffic load in downtown Manhattan may reach unsustainable levels on a specific cellular network between 4 p.m. and 6 p.m., whereas the cellular traffic load at the same location may be relatively low and sustainable on the cellular network between 10 a.m. and 1 p.m. Thus, in this example, a determination may be made that no additional network capacity is needed in downtown Manhattan between 10 a.m. and 1 p.m. whereas some additional network capacity is needed between 4 p.m. and 6 p.m. In some embodiments, the amount of network capacity that one or more Cellular Operators 240 use and/or need at various times and locations is determined based on data provided by User Devices 250, such as, for example, user-experience data as described in FIG. 2 above.

In some embodiments, a determination is made of the amount of network capacity that is offered by one or more other entities, such as one or more WLAN Operators 230, at one or more times and at one or more locations (step 320). For example, the traffic load on a WLAN network at a particular location may be relatively light during some times and relatively heavy at other times. In some embodiments, the amount of network capacity that a WLAN Operator 230 can commit to provide at various times and locations is determined based on data provided by User Devices 250, such as, for example, user-experience data as described in FIG. 2 above.

In some embodiments, a determination is made of the quality of the network capacity that is offered (step 330). For example, the quality may be determined based on data provided by User Devices 250, such as, for example, user-experience data as described in FIG. 2 above. For example, if User Devices 250 provide data indicating that the network capacity has previously been associated with relatively slow speeds, a low quality rating may be determined, whereas if the User Devices 250 provide data indicating that the network capacity has previously been associated with relatively high speeds, a high quality rating may be determined. Thus, for example, past quality associated with the offered network capacity may be used to estimate expected quality. In some embodiments, if the quality of the offered network capacity is not sufficiently high, no bidding will be performed on the network capacity. In some embodiments, the quality of the offered network capacity affects the network capacity's price.

In some embodiments, a determination is then made of one or more offer prices to buy network capacity at a set of times and locations and/or one or more offer prices to sell network capacity at the set of times and locations (step 340). In some embodiments, each bid comprising an offer to buy network capacity or an offer to sell network capacity may be associated with a coverage element. A coverage elements includes, for example, a location (e.g., a particular geographical region serviced by a carrier), a time frame (e.g., a set of times of a day and/or a set of days of a week), and/or a purchase lifetime (e.g., a commitment period during which network capacity remains allocated in accordance with an auction's results).

In some embodiments, a recommended offer price to buy or sell network capacity at a given time and location may be determined using the equation:

Min_offer_bid(Mbyte)=Mbyte_production_cost_at_location/time·K_{c}·K_{w}, where

$${K}_{c} = \frac{Mean\_Cell \_data \_speed}{Actual\_Cell \_data \_speed \_at \_location / time} , \\ and$$

$${K}_{w} = \frac{Mean\_Wifi \_data \_speed}{Actual\_data \_Wifi \_speed \_at \_location / time} ,$$

wherein Mbyte_production_cost_at_location/time represents the cost of producing additional network capacity at a given location and time. Mean_Cell_data_speed represents the mean data speed that a cellular network can provide, Actual_Cell_data_speed_at_location/time represents the data speed that a cellular network can provide at a given location and time, Mean_WiFi_data_speed represents the mean data speed that a WLAN network can provide, and Actual_data_WiFi_speed_at_location/time represents the data speed that a WLAN network can provide at a given location and time.

Thus, for example, as the actual data speed provided by a Cellular Operator 240 at the time and location decreases, the offer price to buy or sell network capacity and the time and location may increase. Similarly, for example, as the actual data speed provided by a WLAN Operator 230 at the time and location decreases (an indication of short supply), the offer price to buy or sell network capacity and the time and location may increase. In alternative embodiments, other formulas can also be used to determine offer prices to purchase or sell network capacity. For example, additional variables, such as a quality parameter, may also affect the offer prices.

In some embodiments, the offer prices are automatically adopted. For example, a Cellular Operator 240 may agree to always purchase network capacity for a coverage element for its offer price. Similarly, for example, a WLAN Operator 230 may agree to always sell network capacity for a coverage element for its offer price.

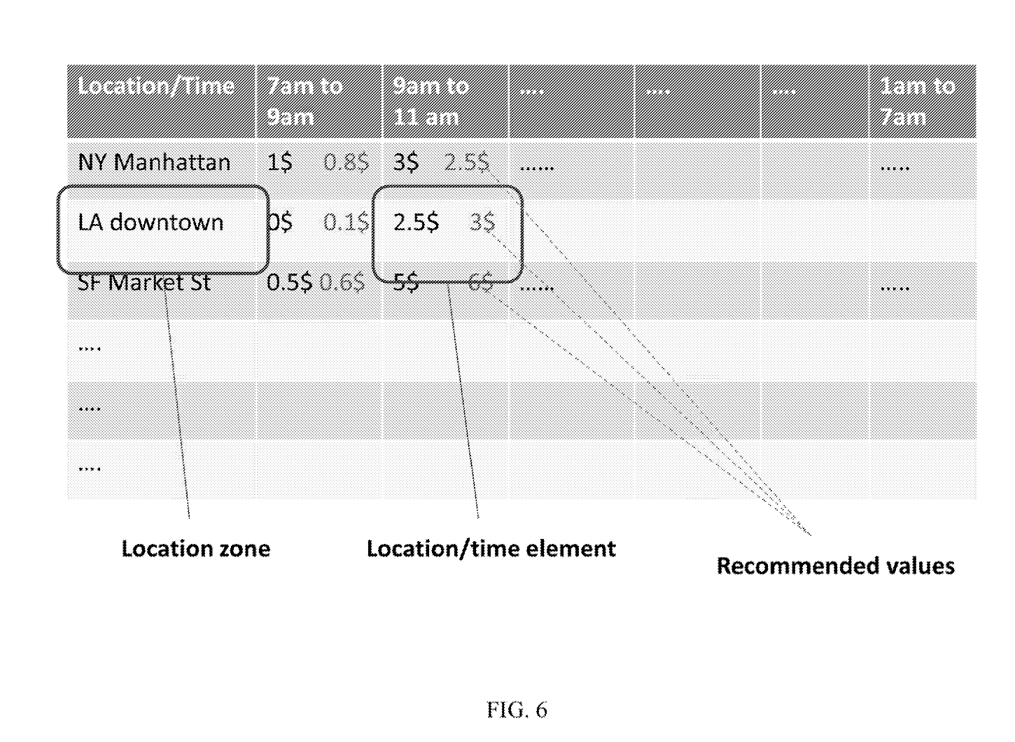

In other embodiments, a purchasing or selling entity chooses whether to adopt or revise an offer price. For example, an interface, as depicted in FIG. 6, with various locations and various times may be provided by Bid Server 210 and interacted with by a Cellular Operator 240 using, for example, a user interface. The interface may initially be populated with recommended bids for purchasing network capacity at various times and locations or may initially be empty and require the one or more Cellular Operators 240 to enter bids. Regardless of whether the matrix is populated with recommended bids, a Cellular Operator 240 may enter additional bids, such as, for example, bids that deviate from the recommended bids based on other factors such as competition from other Cellular Operators 240. In some embodiments, the one or more Cellular Operators 240 may choose to ignore some times and/or locations. The one or more WLAN Operators 230 may enter offer prices to sell network capacity in substantially the same manner as the one or more Cellular Operators 240 enter offer prices to buy network capacity. In some embodiments, however, each of the one or more WLAN Operators 230 can only enter offer prices to sell network capacity for locations in which the WLAN Operator 230 has networks providing service.

In some embodiments, the available network capacity for a coverage element is allocated based on the offer prices to buy and/or sell the network capacity (step 350). For example, Bid Server 210 may store bids comprising offer prices to purchase network capacity and/or offer prices to sell network capacity as they are received. In some embodiments. Bid Server 210 determines when network capacity should be allocated. For example, Bid Server 210 may allocate network capacity at one or more predetermined times throughout the day, such as, for example, at a predetermined time before the start of a time period covered by network capacity that is being auctioned. Additionally, for example, Bid Server 210 may allocate network capacity once a predetermined number of bids are received.

Bid Server 210 may determine the highest offer price to purchase network capacity for a coverage element and determine whether the highest offer price to purchase is above the lowest offer price to sell network capacity for the coverage element. Bid Server 210 may then determine that the network capacity for the coverage element will be sold at the average of the highest offer price to purchase and lowest offer price to sell the network capacity. Then, for example, the network capacity may be allocated to the Cellular Operator 240 associated with the highest offer price to purchase the network capacity. In some embodiments, if more than one Cellular Operator 240 places bids above an offer price to sell network capacity, more than one Cellular Operator 240 can be allocated network capacity if enough network capacity is available. In some embodiments, if more than one Cellular Operator 240 place bids above an offer price to sell network capacity, the Cellular Operator 240 associated with the highest bid is allocated network capacity if enough network capacity is not available fir all of the Cellular Operators 240. Moreover, if more than one WLAN Operator 230 place bids below an offer price to purchase network capacity, network capacity from more than one WLAN Operator 230 can be allocated to Cellular Operators 240.

In some embodiments, the offer prices alone may not determine the assignment of network capacity. In some embodiments, legal obligations, state regulations, federal regulations, and/or past experiences between any of Cellular Operator 240, WLAN Operator 230, Bid Server 210, and/or Connection Management Server 220 are also used to determine the assignment of network capacity. For example, an offer price to purchase or sell network capacity may be weighted by a variable determined based on legal obligations and/or past experiences between any of Cellular Operator 240, WLAN Operator 230, Bid Server 210, and/or Connection Management Server 220. Thus, for example, if a bid for network capacity is received from a Cellular Operator 240 that is associated with a low past experience, network capacity may be assigned to a different Cellular Operator 240 with a lower bid but associated with a higher past experience. Similarly, if a bid offering network capacity is received from a WLAN Operator 230 that is associated with a low past experience, network capacity may be assigned from a different WLAN Operator 230 with a higher bid but associated with a higher past experience. In some embodiments, the actual bid amounts can also be adjusted up or down based on the past experiences. Legal obligations, state regulations, and federal regulations may be accounted for in the same or a similar manner as past experiences.

In some embodiments, Bid Server 210 stores data regarding the determination of how to assign network capacity. For example, Bid Server 210 may store for future use data identifying a Cellular Operator 240 that will be assigned network capacity, the Cellular Operator's bid, data identifying a WLAN Operator 230 that will be providing network capacity, and/or the WLAN Operator's bid. The data stored by Bid Server 210 may be used for and augmented by, future network capacity assignments. For example, as described in more detail below, after assigning the network capacity, User Devices 250 may report to Connection Management Server 220 that the wireless network associated with the network capacity had a low quality. Bid Server 210 may then associate the stored identification data of WLAN Operator 230 with a low rating for past experience. Bid Server 210 may also receive data regarding legal obligations, state regulations, or federal regulations associated with WLAN Operator 230 or Cellular Operator 240 that may also be associated with the stored identification data of WLAN Operator 230 or Cellular Operator 240, respectively. Bid Server 210 may utilize the stored data regarding past experience, legal obligations, state regulations, and/or federal regulations as described above when making future network capacity allocation determinations.

In some embodiments, once it is determined how the network capacity will be allocated, the network capacity is allocated. The network capacity may be allocated, for example, as described in U.S. Pat. No. 8,000,276, which is incorporated herein by reference. For example, Connection Management Server 220 may charge the Cellular Operator 240 having a winning bid an amount based on the winning bid and may pay the WLAN Operator 230 associated with the network capacity being allocated an amount based on the winning bid.

Moreover, for example, Connection Management Server 220 may send User Devices 250 information regarding the networks associated with one or more coverage elements from the auction, such as, for example, login information and network capacity for use. For example, if a particular Cellular Operator 240 wins network capacity associated with one or more coverage elements, each User Device 250 associated with the particular Cellular Operator 240 may be sent the information regarding the one or more coverage elements. Alternatively, for example, if a particular Cellular Operator 240 wins network capacity associated with one or more coverage elements, each User Device 250 associated with the particular Cellular Operator 240 may be sent the information regarding the one or more coverage elements that are associated with a location that is also associated with the User Device 250. Connection Management Server 220 may also instruct User Devices 250 to connect to one or more WLAN networks associated with the one or more coverage elements at a rate determined by the results of the auction. For example, once the amount of network capacity offered for a coverage element that was auctioned is used, User Devices 250 may be prevented from connecting to the one or more WLAN networks associated with the coverage element. Moreover, for example, Connection Management Server 220 may also provide User Devices 250 with the purchase lifetime associated with each of the coverage elements, such that alter the purchase lifetime expires the User Devices 250 may be prevented from connecting to the one or more WLAN networks associated with the coverage elements.

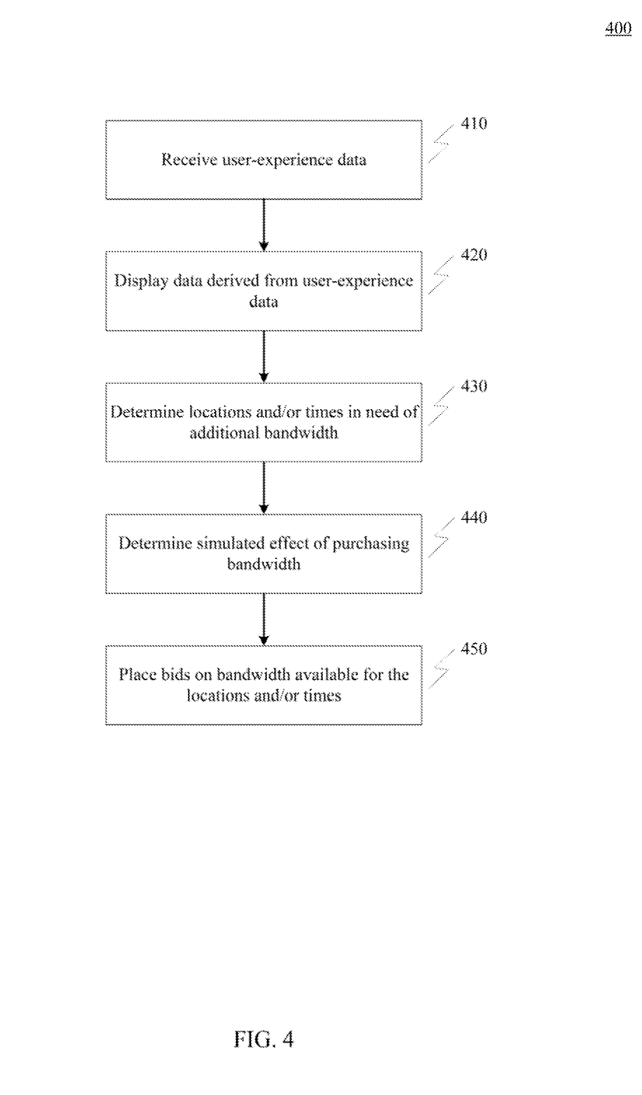

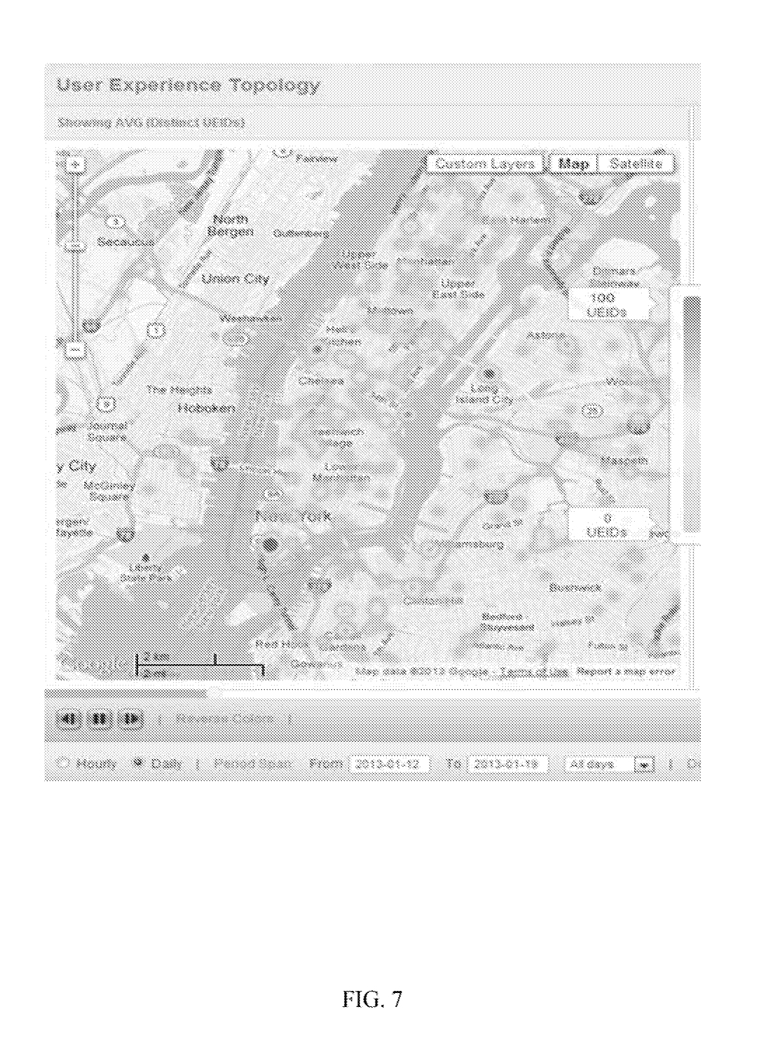

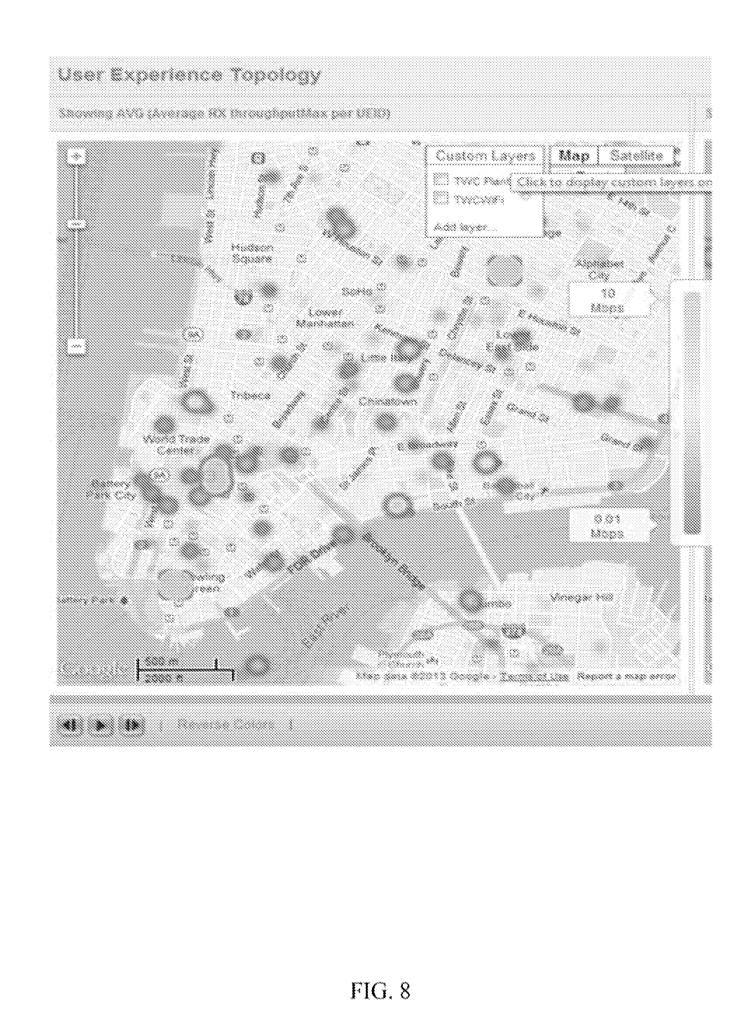

FIG. 4 depicts an example method 400 for placing bids on network capacity. In some embodiments method 400 may be implemented as one or more computer programs. Method 400 begins by receiving user-experience data (step 410). For example, Connection Management Server 220 may receive user-experience data from user devices 250. In some embodiments, data is displayed to one or more Cellular Operators 240 and/or one or more WLAN Operators 230 based on the user-experience data (step 420). For example, as depicted in FIG. 7, a map of a geographic region overlaid with a Cellular Operator's user density distribution may be displayed. Similarly, for example, as depicted in FIG. 8, a map of a geographic region overlaid with a Cellular Operator's network capacity distribution may be displayed. In some embodiments, a user can interact with the map such as by, for example, zooming in, zooming out, or panning in any direction.

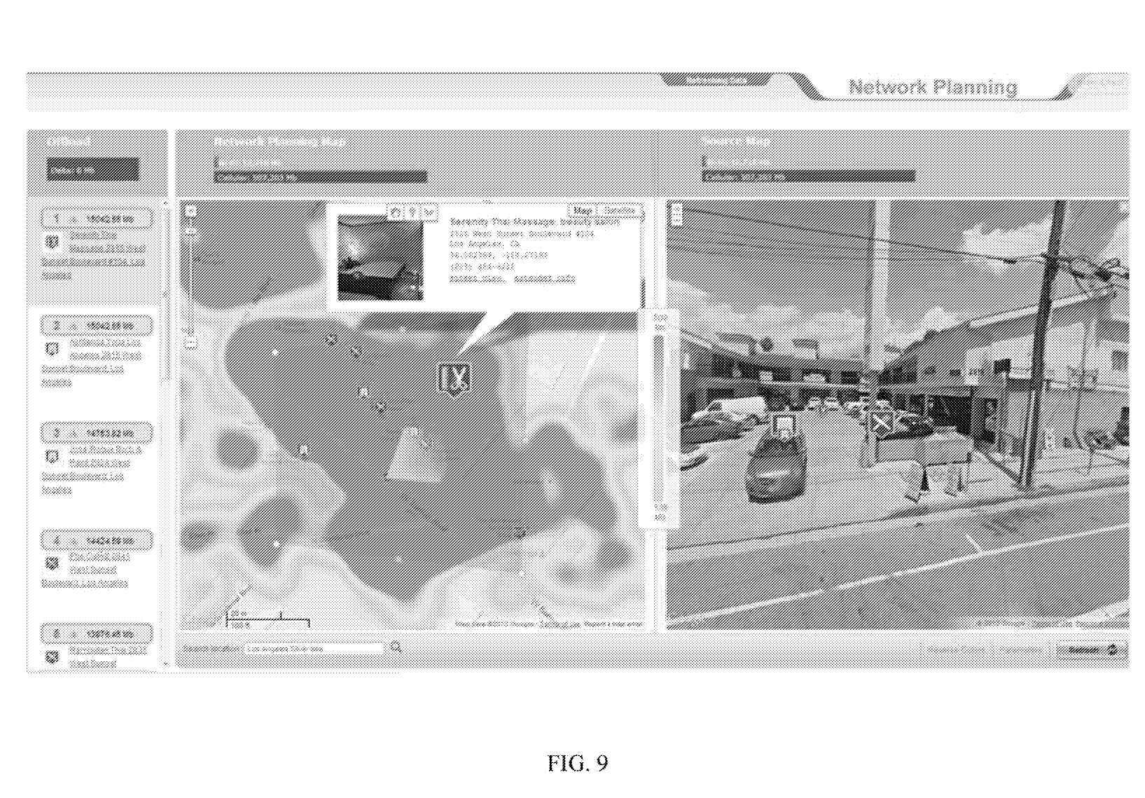

some embodiments, the displayed data is used to identify one or more locations and times in need of additional network capacity (step 430). For example, a Cellular Operator 240 may determine that at a given location at a given time, the network capacity used is too high based on the displayed map. In some embodiments, networks associated with a WLAN Operator 230 near the determined location are displayed. For example, as depicted in FIG. 9, a Cellular Operator 240 may draw the boundaries of a region on the map in need of additional network capacity. Then, for example, networks associated with a WLAN Operator 230 that service at least some of the region defined by the Cellular Operator 240 may be displayed. In some embodiments, the network capacity available from such networks on average and/or at a particular time is also displayed.

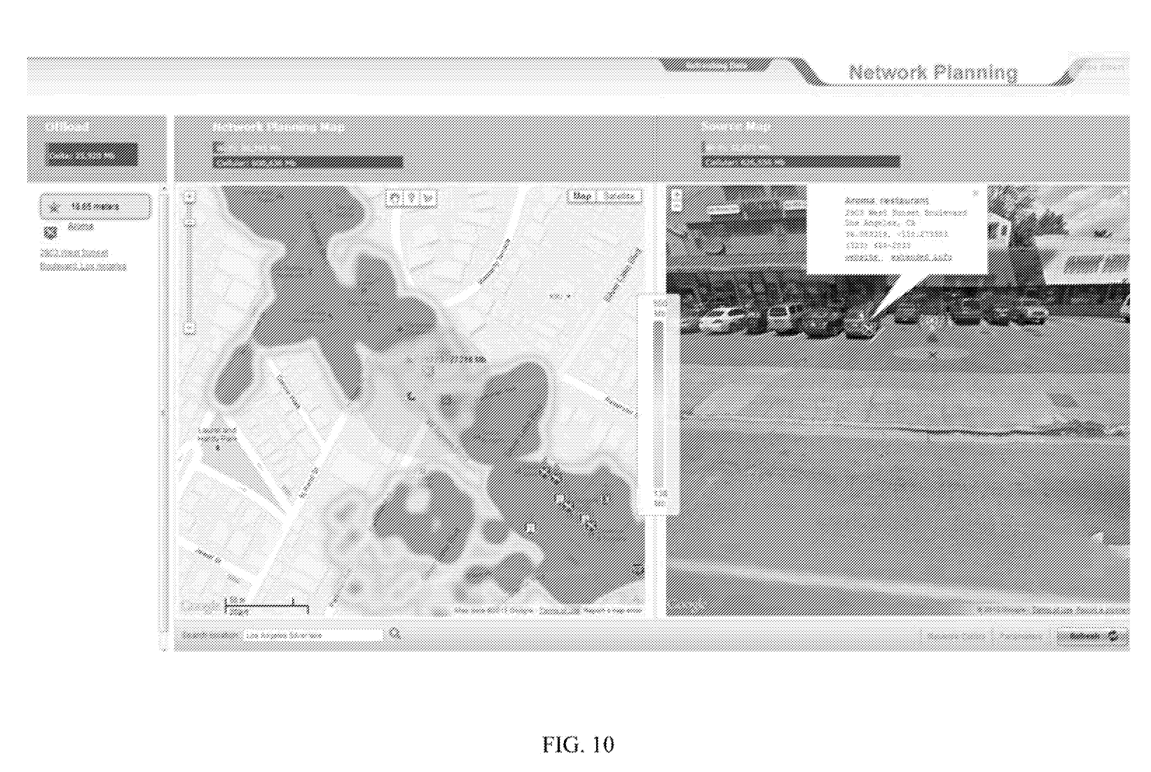

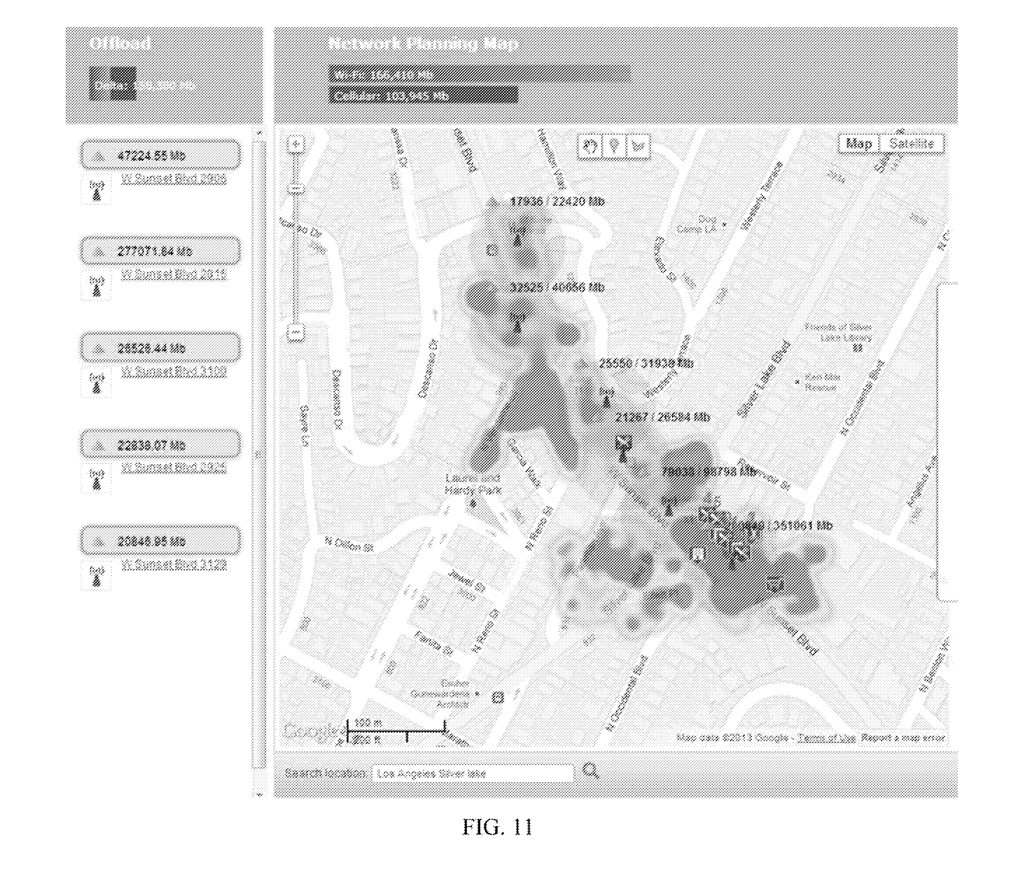

In some embodiments, the effect of purchasing network capacity from a particular network is simulated (step 440). For example, as depicted in FIG. 10, the network capacity that the network can provide at various areas may be subtracted from the displayed network capacity distribution. Such subtraction may take into account the likelihood that a User Device 250 will connect to the network. For example, at a particular location, the network capacity that the network can provide may be multiplied by the probability that the User Device 250 will choose the network before subtracting the resulting value from the displayed network capacity distribution. FIG. 11 depicts an example in which the effect of purchasing network capacity from additional networks is simulated. A Cellular Operator 240 may, for example, utilize the simulation to determine whether to bid on the network capacity that the network can provide. In some embodiments, WLAN Operators 230 and/or Cellular Operators 240 place bids on the available network capacity in substantially the same manner as described above with regard to steps 310-350 of FIG. 3 (step 450).

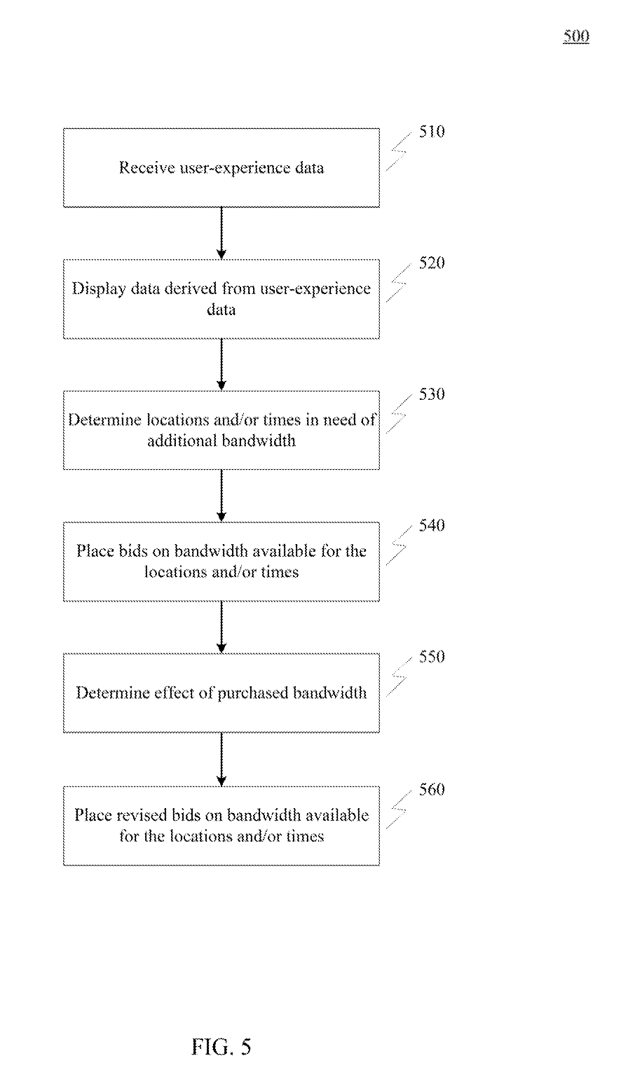

FIG. 5 depicts an example method 500 for placing bids on network capacity. In some embodiments method 500 may be implemented as one or more computer programs. Steps 510-530 of method 500 are performed in substantially the same manner as steps 410-430 of FIG. 4. In addition, in some embodiments, WLAN Operators 230 and/or Cellular Operators 240 place bids on the network capacity in substantially the same manner as described above with regard to steps 310-350 of FIG. 3 (step 540).

In some embodiments, after allocating the network capacity to Cellular Operator 240 for a coverage element, the effect of allocating the network capacity is determined (step 550). For example, the effect may be determined based on user-experience data received by Connection Management Server 220 from User Devices 250. In some embodiments, the user-experience data is used to derive past experience data to store in Bid Server 210 and associate with the WLAN Operator 230 associated with the allocated network capacity. For example, as described above, if the user-experience data indicates that the wireless network associated with the allocated network capacity had a low quality, WLAN Operator 230 may be associated with a low rating for past experience. Additionally, for example, if the user-experience data indicates that the actual network capacity of the wireless network associated with the allocated network capacity deviated from the offered network capacity by more than a predetermined amount, WLAN Operator 230 may be associated with a low rating for past experience.

In some embodiments, WLAN Operators 230 and/or Cellular Operators 240 can then place revised bids on the network capacity based on the actual effect of the network capacity (step 560). For example, as described above, the past experience data associated with the WLAN Operator 230 associated with the previously allocated network capacity may be used to adjust bids from other WLAN Operators and/or Cellular Operators 240 (including, but not limited to, a Cellular Operator 240 that had purchased the previously allocated available network capacity) for network capacity offered by the WLAN Operator 230 up or down and/or to weight bids from other WLAN Operators and/or Cellular Operators 240 for network capacity offered by WLAN Operator 230 up or down. In some embodiments, only bids associated with the particular wireless network associated with a past experience are adjusted or weighted based on the past experience. In other embodiments, bids associated with some or all of the wireless networks offered by WLAN Operator 230 are adjusted or weighted based on a past experience associated with a wireless network offered by the WLAN Operator 230.

Embodiments and all of the functional operations described in this specification can be implemented in digital electronic circuitry, or in computer software, firmware, or hardware, including the structures disclosed in this specification and their structural equivalents, or in combinations of them. Embodiments can be implemented as one or more computer program products, i.e., one or more modules of computer program instructions encoded on a computer readable medium, e.g., a machine readable storage device, a machine readable storage medium, a memory device, or a machine readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, which is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification (e.g., FIGS. 3-5) can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessor, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client/server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments have been described. Other embodiments are within the scope of the following claims.

What is claimed is:

1. A network capacity management system, comprising:
at least one processor,
at least one memory device comprising instructions which, when executed by the at least one processor, cause the network capacity management system to perform the steps of:
determining network capacity associated with a first wireless network;
determining network capacity associated with a second wireless network;
outputting data generated based, at least in part, on the first wireless network capacity determination and the second wireless network capacity determination;
receiving one or more bids associated with at least some of the network capacity associated with the first wireless network; and
assigning at least some of the network capacity associated with the first wireless network to a purchaser system associated with the second wireless network based, at least in part, on the one or more received bids.

2. The network capacity management system of claim 1, wherein the first network is a wireless local area network and the second network is a cellular network.

3. The network capacity management system of claim 1, wherein determining the network capacity associated with the first wireless network comprises analyzing past user experiences of data speeds achieved using the first wireless network.

4. The network capacity management system of claim 1, wherein the outputted data comprises a bid associated with at least some of the network capacity associated with the first wireless network determined based, at least in part, on a cost associated with the network capacity associated with the first wireless network or a cost associated with the network capacity associated with the second wireless network.

5. The network capacity management system of claim 4, wherein the bid associated with at least some of the network capacity is further determined based, at least in part, on an average data speed associated with the first wireless network, an actual data speed associated with the first wireless network for a coverage element, an average data speed associated with the second wireless network, and an actual data speed associated with the second wireless network for the coverage element.

6. The network capacity management system of claim 1, further comprising a display, wherein the instructions, when executed by the at least one processor, further cause the network capacity management system to perform the step of:
displaying a simulation representative of an effect associated with the assigning of at least some of the network capacity associated with the first wireless network to the purchaser system associated with the second wireless network.

7. The network capacity management system of claim 1, wherein the instructions, when executed by the at least one processor, further cause the network capacity management system to perform the steps of:
receiving data representative of an effect associated with the assigning of at least some of the network capacity associated with the first wireless network to the purchaser system associated with the second wireless network; and
receiving one or more adjusted bids associated with at least some of the network capacity associated with the first wireless network based on the received data.

8. The network capacity management system of claim 1, wherein assigning the network capacity is further based on one or more of: past experiences associated with the purchaser system associated with the second wireless network, past experiences associated with a selling system associated with the first wireless network, legal obligations associated with the purchaser system associated with the second wireless network, or legal obligations associated with the selling system associated with the first wireless network.

9. The network capacity management system of claim 1, wherein the at least some of the network capacity is assigned for a coverage element.

10. The network capacity management system of claim 9, wherein the coverage element comprises a set of locations and a set of times in which devices associated with the purchaser system are permitted to use at least some network capacity of the first wireless network, and wherein the coverage element further comprises a purchase lifetime after which the devices are not permitted to use network capacity of the first wireless network.

11. A method for a network capacity management system, comprising:
determining network capacity associated with a first wireless network;
determining network capacity associated with a second wireless network;
outputting data generated based, at least in part, on the first wireless network capacity determination and the second wireless network capacity determination;
receiving one or more bids associated with at least some of the network capacity associated with the first wireless network; and
assigning at least some of the network capacity associated with the first wireless network to a purchaser system associated with the second wireless network based, at least in part, on the one or more received bids.

12. The method of claim 11, wherein the first network is a wireless local area network and the second network is a cellular network.

13. The method of claim 11, wherein determining the network capacity associated with the first wireless network comprises analyzing past user experiences of data speeds associated with the first wireless network.

14. The method of claim 11, wherein the outputted data comprises a bid associated with at least some of the network capacity associated with the first wireless network determined based, at least in part, on a cost associated with the network capacity associated with the first wireless network or a cost associated with the network capacity associated with the second wireless network.

15. The method of claim 14, wherein the bid associated with at least some of the network capacity is further determined based, at least in part, on an average data speed associated with the first wireless network, an actual data speed associated with the first wireless network for a coverage element, an average data speed associated with the second wireless network, and an actual data speed associated with the second wireless network for the coverage element.

16. The method of claim 11, further comprising:
displaying a simulation representative of an effect associated with the assigning of at least some of the network capacity associated with the first wireless network to the purchaser system associated with the second wireless network.

17. The method of claim 11, further comprising;
receiving data representative of an effect associated with the assigning of at least some of the network capacity associated with the first wireless network to the purchaser system associated with the second wireless network; and
receiving one or more adjusted bids associated with at least some of the network capacity associated with the first wireless network based on the received data.

18. The method of claim 11, wherein assigning the network capacity is further based on one or more of: past experiences associated with the purchaser system associated with the second wireless network, past experiences associated with a selling system associated with the first wireless network, legal obligations associated with the purchaser system associated with the second wireless network, or legal obligations associated with the selling system associated with the first wireless network.

19. The method of claim 11, wherein the at least some of the network capacity is assigned for a coverage element.

20. The method of claim 19, wherein the coverage element comprises a set of locations and a set of times in which devices associated with the purchaser system are permitted to use at least some network capacity of the first wireless network, and wherein the coverage element further comprises a purchase lifetime after which the devices are not permitted to use network capacity of the first wireless network.

21. A non-transitory computer-readable medium comprising instructions for an electronic device, the instructions being executable by a processor of the electronic device for causing the electronic device to perform operations comprising:
determining network capacity associated with a first wireless network;
determining network capacity associated with a second wireless network;
outputting data generated based, at least in part, on the first wireless network capacity determination and the second wireless network capacity determination;
receiving one or more bids associated with at least some of the network capacity associated with the first wireless network; and
assigning at least some of the network capacity associated with the first wireless network to a purchaser system associated with the second wireless network based, at least in part, on the one or more received bids.

22. The non-transitory computer-readable medium of claim 21, wherein the first network is a wireless local area network and the second network is a cellular network.

23. The non-transitory computer-readable medium of claim 21, wherein determining the network capacity associated with the first wireless network comprises analyzing past user experiences of data speeds associated with the first wireless network.

24. The non-transitory computer-readable medium of claim 21, wherein the outputted data comprises a bid associated with at least some of the network capacity associated with the first wireless network determined based, at least in part, on a cost associated with the network capacity associated with the first wireless network or a cost associated with the network capacity associated with the second wireless network.

25. The non-transitory computer-readable medium of claim 24, wherein the bid associated with at least some of the network capacity is further determined based, at least in part, on an average data speed associated with the first wireless network, an actual data speed associated with the first wireless network for a coverage element, an average data speed associated with the second wireless network, and an actual data speed associated with the second wireless network for the coverage element.

26. The non-transitory computer-readable medium of claim 21, wherein the instructions further cause the electronic device to perform operations comprising:
displaying a simulation representative of an effect associated with the assigning of at least some of the network capacity associated with the first wireless network to the purchaser system associated with the second wireless network.

27. The non-transitory computer-readable medium of claim 21, wherein the instructions further cause the electronic device to perform operations comprising:
receiving data representative of an effect associated with the assigning of at least some of the network capacity associated with the first wireless network to the purchaser system associated with the second wireless network; and
receiving one or more adjusted bids associated with at least some of the network capacity associated with the first wireless network based on the received data.

28. The non-transitory computer-readable medium of claim 21, wherein assigning the network capacity is further based on one or more of: past experiences associated with the purchaser system associated with the second wireless network, past experiences associated with a selling system associated with the first wireless network, legal obligations associated with the purchaser system associated with the second wireless network, or legal obligations associated with the selling system associated with the first wireless network.

29. The non-transitory computer-readable medium of claim 21, wherein the at least some of the network capacity is assigned for a coverage element.

30. The non-transitory computer-readable medium of claim 29, wherein the coverage element comprises a set of locations and a set of times in which devices associated with the purchaser system are permitted to use at least some network capacity of the first wireless network, and wherein the coverage element further comprises a purchase lifetime after which the devices are not permitted to use network capacity of the first wireless network.
